(19) United States
(12) Patent Application Publication
(10) Pub. No.: US 2009/0134547 A1
(43) Pub. Date: May 28, 2009

(54) Process for the production of an extruded plastic film and use of the plastic film

(76) Inventors: Michael Bauer, Forchheim (DE); Roland Kelm, Forchheim (DE); Josef Mueller, Eggolsheim (DE)

Correspondence Address: COLLARD & ROE, P.C., 1077 Northern Boulevard, Roslyn, NY, 11576-1696, US

(21) Appl. No.: 12/315,717

(22) Filed: Dec. 5, 2008

Related U.S. Application Data
(63) Continuation of application No. PCT/EP2007/055651, filed on Jun. 8, 2007.

(30) Foreign Application Priority Data
Jun. 8, 2006 (DE) 10 2006 027 004.5

(51) Int. Cl. B29C 47/00

(52) U.S. Cl. 264/211.12

(57) ABSTRACT

Process for the production of an extruded mono- or multilayer plastic film, where at least sections of the plastic film are provided with a pattern during or after extrusion, and use of a film produced by this process for packaging purposes.

The invention relates to a process for the production of a mono- or multilayer plastic film as well as to the use made of the plastic film. Such films are often used for packaging purposes.

The aim of the invention is to indicate a process for the production of a mono- or multilayer plastic film with which a film that has good initial tearing and tear propagation properties can be produced and where the film has a preferred tear propagation direction.

In the solution to this problem proposed by the invention, at least sections of the plastic film are provided with a pattern during or after extrusion.

This makes it possible for the film to be given defined tear properties.

It is very advantageous if the pattern is produced by embossing.

Embossed patterns are particularly easy to apply in precisely defined locations.

It has also proved to be very advantageous in accordance with the invention if a groove pattern is provided.

This enables tears to be channeled very effectively in a desired direction.

It has also proved to be very advantageous in accordance with a further development of the invention if the pattern is aligned in the longitudinal direction of the film.

The pattern can be applied to the film very easily and continuously as a result.

It has, however, also proved to be very advantageous if the pattern is aligned at right angles to the longitudinal direction of the film.

It is also very advantageous in accordance with the invention if the pattern is aligned at an angle to the longitudinal direction of the film.

Different directions for tears can be defined for both developments with little effort too.

In another very advantageous further development of the invention, a line or criss-cross line pattern is provided.

This makes it possible for the tear to extend in different but defined directions too. The line patterns do not necessarily have to be straight; they can, for example, be wavy instead.

In another very advantageous further development of the invention, the film is produced by the blown process.

The blown process has proved to be a very good way to produce inexpensive but nevertheless high-quality films.

It is also very advantageous if the film is produced by the cast process.

Inexpensive but nevertheless high-quality films can be produced by the cast process too. The cast process is also a good way to provide the film with the required pattern using patterned pressure and/or stretching rollers, for example.

In another very advantageous further development of the invention, the layers of the film are extruded or laminated to a substrate at least to some extent.

Further film structures can be produced in this way. It is conceivable in this context that the substrate is patterned and, if necessary, transfers its pattern to at least one adjacent film layer.

It is also very advantageous if the film is cooled down to its crystalline temperature range when it is being produced.

It has been determined that the plastic film produced in this way has good tear propagation properties as a result.

In another advantageous further development of the invention, the plastic film is cooled on both sides, i.e. on both the outside and the inside of the tubular plastic film during blown film production.

The tear propagation properties are improved even more as a result.

It has also proved to be very advantageous if the cooling operation is carried out via air at a regulated temperature.

The cooling process can be controlled very precisely as a result.

It is also particularly advantageous if the cooling operation is carried out with a defined cooling gradient.

The properties given to the film can be set particularly effectively by specifying a defined cooling gradient.

In another very advantageous further development of the invention, the cooling operation is carried out with a defined temperature gradient.

The properties are influenced by this as well. Concerted arrangement and/or specification of the molecule chains is possible as a result.

It is also extremely advantageous in accordance with the invention if the cooling operation is carried out with different temperatures on the inside and outside of the tubular plastic film.

The properties of the plastic film are influenced by this as well.

In another advantageous further development of the invention, the cooling facilities are followed by what is known as an annealing zone.

The process in accordance with the invention is improved even more if the blow-up ratio between the extrusion gap and the finished tubular film in blown film production is smaller than 2.5 and preferably smaller than 1.8.

It has also proved to be very advantageous if in accordance with the invention the gap width of the extrusion die is at least 1.0 mm and preferably at least 1.5 mm.

In accordance with an advantageous further development of the invention, a film is produced that has a final thickness of 1 μm to 1500 μm and preferably of 30 μm to 300 μm.

It has also proved to be extremely advantageous in accordance with a further development of the invention if the depth of the pattern is between 1 and 1000 μm, preferably between 5 and 300 μm and in particular between 10 and 20 μm.

It is also very advantageous if the pattern has a groove width of 1 to 1000 μm, preferably between 10 and 500 μm and in particular between 40 and 80 μm.

It is also very advantageous if the pattern has a groove interval of 1 to 1000 μm, preferably between 100 and 500 μm and in particular between 200 and 300 μm.

Excellent tear properties are achieved with such pattern dimensions.

It is also very advantageous in accordance with the invention if the pattern is applied on one side.

This guarantees on the one hand the desired tear properties combined on the other hand with a smooth film surface.

It has proved to be very advantageous in accordance with another further development of the invention if the plastic film and/or some of the layers of the plastic film are produced from a polyolefin, PET, PA and/or a biologically degradable plastic and/or a blend of these plastics with different materials as well.

It is very advantageous in this context if the plastic film is produced from a PLA.

These materials have proved to be very advantageous for the process in accordance with the invention. In addition to this, barrier properties can also be produced very effectively as a result for the packs that are being manufactured.

It has also proved to be very advantageous in accordance with another further development of the invention if the plastic film is produced from a plastic with poor tear properties.

Use of a plastic with poor tear properties makes sure that different tear properties are not superimposed and that the tear properties are instead determined exclusively by the production process in accordance with the invention.

It is very advantageous in accordance with the invention if the plastic film is produced from a PP with poor tear properties.

It has been demonstrated that there are numerous polypropylenes with poor tear properties.

In another advantageous further development of the process in accordance with the invention, the plastic film is produced as a monofilm from PP homopolymer.

It is also very advantageous if in accordance with another further development of the process proposed by the invention the plastic film is produced as a monofilm from blends of PP homopolymer with E/P and/or random PP.

In another very advantageous further development of the process in accordance with the invention, the plastic film is produced by the coextrusion process, with at least one of the coextruded layers consisting of PP homopolymer.

In another very advantageous further development of the invention, the PP homopolymer is intrinsically nucleated.

It is also very advantageous if the melt flow index (MFI) of the film material is greater than 0.8 and preferably greater than 1.5.

The desired film properties are improved even more by both these measures.

The films in accordance with the invention can be used particularly advantageously in accordance with another further development of the invention if the plastic film is used for a pack.

The packs produced can be opened easily but at the same time in a defined way as a result.

It has also proved to be extremely advantageous in this context if the plastic film is combined with further layers of packaging material.

It is very advantageous in accordance with the invention in this context if the plastic film is laminated to further packaging materials.

Packs that are adapted very effectively to the relevant application can be produced as a result.

In another further development, it is very advantageous if the plastic film determines the tear properties of the pack.

This means that not only the plastic film but also the entire pack, which can be made from several different packaging materials, tears in a defined way.

One embodiment of the invention is shown in the drawings.

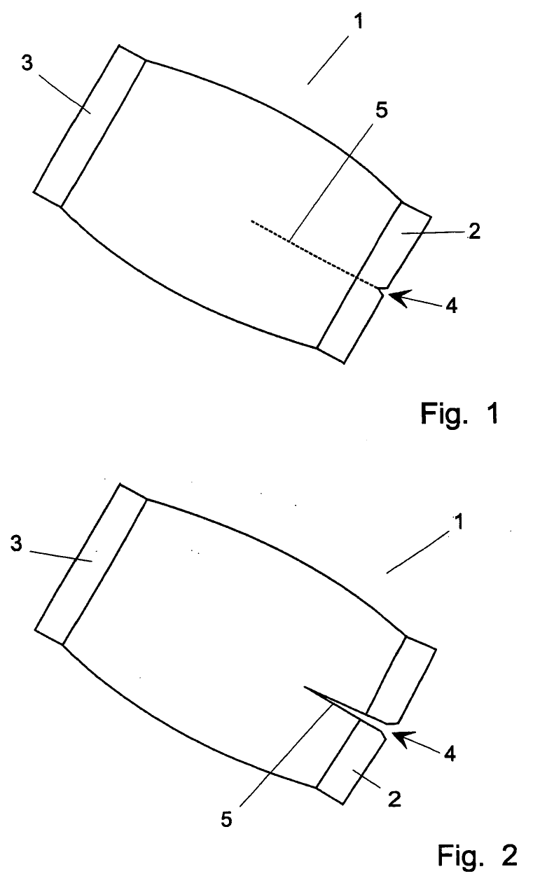

FIG. 1 is a pack produced using a plastic film in accordance with the invention, where the pack is closed,

FIG. 2 is another pack that has been torn open,

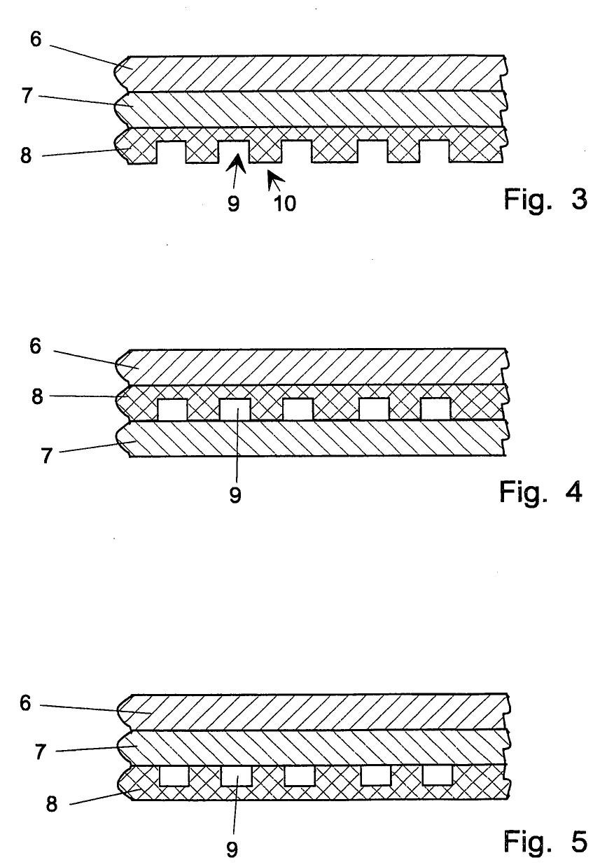

FIG. 3 is a cross section of a pack structure in accordance with the invention,

FIG. 4 is a cross section of a second pack structure in accordance with the invention and

FIG. 5 is a cross section of a third pack structure in accordance with the invention.

1 in FIG. 1 is a flexible pack, which is configured as a flowpack in this embodiment. The pack 1 is closed at both ends by sealed seams 2 and 3. One of the sealed seams 2 has a notch 4 in it, so that the pack is easier to tear open.

If the pack 1 is torn open starting at the notch 4, the tear follows a predetermined line 5. Easier or more difficult initial tearing properties can be provided according to the packaging material and/or structure chosen.

Tearing along a predetermined line or path depends on the structure of the pack, which is illustrated by the example given in FIG. 3.

This pack structure involves a top layer 6 made from PET, a central layer 7 made from aluminium or a similar material and a plastic film layer 8. The plastic film layer 8 is provided on at least one side with a pattern that consists of a large number of grooves 9 that are aligned parallel to each other.

Different patterns are also conceivable. It is, for example, conceivable that individual grooves 9 are provided that do not necessarily have to be linear and/or parallel to each other. Criss-cross patterns can also be provided. The pattern can be provided partially as well.

It is also conceivable that the plastic layer 8 is located between two layers 6 and 7, as is shown in FIG. 4. It is in addition conceivable that the grooves 9 are provided on the side facing the other layers 6 and 7, as is shown in FIG. 5.

If the pack 1 is now torn open starting at the notch 4, the tear is channeled along one of the grooves 9. If the tear drifts out of this groove 9—because of material inhomogeneity or for similar reasons—it is channeled by the next groove 9. The grooves 9 are so pronounced that they succeed in channeling the tear in spite of further layers of other packaging materials which have undefined tear properties.

The grooves 9 and/or the ridges 10 located between the grooves 9 have a width of 10 to 1000 μm and preferably between 300 and 500 μm. The depth of the grooves 9 is between 10 and 1000 μm and preferably between 100 and 300 μm.

A plastic film of this kind that determines the tear properties of a pack can be produced by providing it with the pattern during or after extrusion.

The pattern is embossed in the film in this context and can be oriented in the longitudinal direction of the film in the case of continuous production. Different orientations at an angle to the longitudinal direction of the film are conceivable as well.

It is, however, also conceivable that the desired pattern is already produced at least to some extent by varying the shape of the extrusion die accordingly.

Plastic materials with poor tear properties are generally used to produce this plastic film, so that the tear properties of the finished plastic film are determined by the pattern of the latter and the production process used to make it and so that no undesirable effects occur which are attributable to the material.

It is therefore also conceivable that intrinsically nucleated polypropylene homopolymer with an MFI of greater than 2 is extruded on a blown film line. The gap width of the extruder is set to be 2 mm in this context. The tubular film take-off and blow-up systems are set in such a way that the blow-up ratio is 1.6.

The tubular film is cooled shortly after extrusion. The cooling operation can be carried out by supplying internal and/or external cooling air, for example.

It is conceivable in this context that the cooling operation is carried out not only particularly quickly but also in several stages, as a result of which molecule alignment is “frozen”, for example. It is, however, also conceivable that the cooling operation is carried out via a specified gradient, so that the film is, for example, cooled to approximately room temperature on a linear basis within 30 seconds.

It is, however, also conceivable that not only the cooling gradient but also the temperature difference between the film and cooling is influenced by supplying cooling air of different temperatures, in order to improve the tear properties.

It is possible in addition to this to provide different cooling on the inside and outside of the tubular film, for example, by supplying cooling air of different temperatures.

It is, however, also conceivable that the film is produced by the cast process and the two sides of the film are treated similarly in it.

An additional annealing zone can be provided afterwards, in which the film is heated up again, as a result of which it is the case not only that film flatness and reel quality can be influenced positively but also that the tear properties can be improved even more and can be changed in a defined way.

The films resulting from this are supposed to be between 1 and 1500 μm and preferably between 40 and 300 μm thick and can be made as monofilms from the above-mentioned raw material or blends of it or can take the form of coextruded films with at least one such layer.

Combinations of PETP, aluminium, polypropylene and other comparable materials are often used for packs. Such material combinations are often used for packs which are supposed to be particularly light but are nevertheless required to have defined opening properties. It is considered important in this context that tearing always takes place along a predetermined line or at least approximately along this line. Such tear properties are often produced via lacquers, labels or other means that are very laborious. In these films that have been disclosed in the past, one of the layers of film is often provided with laser perforation too, in order to boost these tear properties. Such properties are known as easy-tear properties.

The plastic film in accordance with the invention is in a position on the one hand to replace such material combinations and on the other hand to optimise them in such a way that they are given the desired tear properties in a simple way without being dependent on additional tearing aids. The tear properties are improved even more by the plastic film produced in accordance with the invention. No perforations are needed. A reduction in the barrier properties of the film is avoided as a result.

The packaging film can be configured to have a single- or multilayer structure. Structures are conceivable in this context that contain any polyolefin, PET, PE and/or biologically degradable plastics like PLA. The films can be produced by the blown or cast process. It is, however, also conceivable that the film layers are laminated to or extruded onto a substrate layer. Uniaxial and biaxial orientation of the complete structure or single layers is conceivable and influences the initial tearing and tear propagation properties of the film structure.

It is also conceivable that paper or other layers apart from the above-mentioned aluminium layers can be incorporated in the structure too.

The patterning can be provided on an outside, inside or between layers.

Conceivable film structures are not just monofilms made from PE, PP, PLA or PET but also, for example, two-layer structures made from PE/PP and OPP/PET. An aluminium layer can be provided between the two plastic layers as well.

Further additional plastic layers are conceivable. It is conceivable above all that barrier layers are provided which can be located both on the outside and in the material structure.

The film structure can in addition be printed and/or provided with release coatings.

1. Process for the production of an extruded mono- or multilayer plastic film, where at least sections of the plastic film are provided on at least one side with a pattern that can be produced by embossing during or after extrusion, wherein the finished film has a thickness of 1 to 1500 μm and preferably of 30 μm to 300 μm, the pattern has a depth of between 1 and 1000 μm, preferably between 5 and 300 μm and in particular between 10 and 20 μm, the pattern has a groove width of 1 to 1000 μm, preferably between 10 and 500 μm and in particular between 40 and 80 μm and the pattern has a groove interval of 1 to 1000 μm, preferably between 100 and 500 μm and in particular between 200 and 300 μm, where a groove pattern can be provided that can take the form of a line pattern or a crisscross line pattern.

2. Process according to claim 1, wherein the pattern is aligned in the longitudinal direction of the film, at right angles to the longitudinal direction of the film or at an angle to the longitudinal direction of the film.

3. Process according to claim 1, wherein the film is produced by the blown process.

4. Process according to claim 1, wherein the film is produced by the cast process.

5. Process according to claim 1, wherein the layers of the film are extruded or laminated to a substrate at least to some extent.

6. Process according to claim 1, wherein the film is cooled down to its crystalline temperature range when it is being produced, in which context the plastic film can be cooled down on both sides, i.e. on both the outside and the inside of the tubular plastic film during blown film production, the cooling operation can be carried out via air at a regulated temperature and cooling can be carried out with different temperatures on the two sides of the plastic film.

7. Process according to claim 1, wherein the cooling operation is carried out with a defined temperature gradient.

8. Process according to claim 1, wherein the cooling facilities are followed by what is known as an annealing zone.

9. Process according to claim 1, wherein the blow-up ratio between the extrusion gap and the finished tubular film in blown film production is smaller than 2.5 and preferably smaller than 1.8.

10. Process according to claim 1, wherein the gap width of the extrusion die is at least 1.0 mm and preferably at least 1.5 mm.

11. Process according to claim 1, wherein the plastic film and/or some of the layers of the plastic film are produced from a polyolefin, PET, PA and/or a biologically degradable plastic and/or a blend of these plastics with different materials as well, with it being possible for a PLA to be provided as the biologically degradable plastic.

12. Process according to claim 1, wherein the plastic film is produced from a plastic with poor tear properties, with it being possible for a PP with poor tear properties to be used.

13. Process according to claim 1, wherein the plastic film is produced as a monofilm from PP homopolymer or from blends of PP homopolymer with E/P and/or random PP, where the PP homopolymer can be intrinsically nucleated, where the plastic film can be produced by the coextrusion process and where at least one of the coextruded layers consists of PP homopolymer and/or blends of PP homopolymer with E/P and/or random PP.

14. Process according to claim 1, wherein the melt flow index (MEI) of the film material is greater than 0.8 and preferably greater than 1.5.

15. Use of a plastic film produced according to claim 1, wherein the plastic film is used for a pack (1), where the plastic film (8) can be combined with further layers of packaging material (6, 7) and the plastic film (8) can be laminated to further packaging materials (6, 7), and the plastic film (8) determines the tear properties of the pack.
